(19) United States
(12) Patent Application Publication
(10) Pub. No.: US 2025/0296092 A1
(43) Pub. Date: Sep. 25, 2025

(54) CRUSHER FEED STATION

(71) Applicant: SANDVIK LTD, Dungannon (GB)

(72) Inventor: Stephen CLANCY, Dungannon (GB)

(21) Appl. No.: 18/864,201

(22) PCT Filed: May 10, 2023
(86) PCT No.: PCT/EP2023/062355

§ 371 Date: Nov. 8, 2024

(30) Foreign Application Priority Data
May 10, 2022 (EP) 22172624.3

(51) Int. Cl. B02C 23/02; B02C 21/02; B02C 23/08

(52) U.S. Cl. CPC B02C 23/02; B02C 21/02; B02C 23/08

(57) ABSTRACT

A crusher feed station is mountable on a crusher mainframe to receive bulk material from a feed hopper and a primary feeder also mounted on the mainframe, in which the crusher feed station has a scalping deck and a sizing screen configured to produce a first sizing screen oversize product, a second fines product and a third intermediate sized product. A crusher including the crusher feed station and a method of feeding feed material from a feeding station to a crusher is also provided.

### FIELD OF INVENTION

This invention relates to a crusher feed station and to a crusher comprising the feed station.

### BACKGROUND OF THE INVENTION

A variety of different crushers have evolved for processing bulk material such as stone, minerals and both domestic and industrial waste including construction materials to generate a crushed product for subsequent processing or disposal. Known crushers include cone, impact, vibration and jaw crushers. Crushers can also be categorised into mobile crushers that are readily transportable from one site to another and stationary crushers designed for large static installations that are assembled on site e.g. at a quarry or mine environment where they remain until the source of raw material is exhausted.

Mobile crushers typically have endless tracks or wheels mounted at the undercarriage of a main chassis of the mobile crusher.

Generally, crushers are provided with a feed station for receiving crusher feed bulk material from a hopper and feeding the bulk material to the crusher. Known feed stations are made up of a feeder such as a vibrating pan feeder for receiving bulk material from a hopper and can include screening apparatus to remove undersize material such as natural fines from the bulk material prior to crushing to prevent blockages in the crusher and improve crusher performance. The removed material can then be combined with the crushed product and/or treated as a useful commercial byproduct of the crushing process e.g. the natural fines.

However, known feed stations can be inefficient at removing undersize material from bulk material and are unable to generate more than one byproduct from the undersize material.

An object of the invention is to provide a crusher feed station adapted to efficiently remove undersize material from a crusher feed bulk material and generate more than one byproduct from the bulk material.

### SUMMARY OF THE INVENTION

According to the invention there is provided a crusher feed station for feeding feed material to a crusher configured to produce a sized crushed product, the crusher feed station comprising:
a primary feeder,
a scalping deck for removing undersize materials from the feed material to form a scalping deck oversize crusher feed and an undersize (underflow) fraction and
a sizing screen beneath the scalping deck for screening the undersize (underflow) fraction wherein the sizing screen comprises at least three screening decks configured to produce or size or produce and size a first sizing screen oversize product, a second fines product and a third intermediate sized product. The crusher feed station optimises crusher efficiency by removing a high percentage of undersize material and producing a clean, saleable third intermediate product in addition to the second fines product.

The feed station may be configured to output each product of the first sizing screen oversize product, the second fines product and the third intermediate sized product as respective finished products.

The crusher feed station has a general feed direction along a longitudinal direction of the feed station. In any embodiment, the feed station is configured to feed the scalping deck oversize crusher feed and the undersize fraction along the feed direction.

Preferably, the undersize fraction is fed, i.e. flows, immediately beneath the oversize crusher feed.

Each deck of the at least three screening decks may extend along the feeding direction from a respective upstream receiving end to a downstream discharge end of the at least three screening decks.

In any embodiment, the scalping deck oversize crusher feed and undersize flow are continuously fed in the feed direction of the feed station.

In any embodiment, the scalping deck is configured to, in operation, feed the scalping deck oversize crusher feed to the crusher, such as conveying the scalping deck oversize crusher feed to the crusher.

In any embodiment, the crusher feed station, in particular the scalping deck, may be configured to, in operation, separate the oversize crusher feed from the undersize fraction. The feed station may be configured such that, in operation, the undersize fraction descend by means of gravity to the sizing screen beneath the scalping deck.

In one embodiment, a first upper deck of the three screening decks comprises a first deck screening media sized to produce the first sizing screen oversize product. The first sizing screen oversize product is therefore sized as required in accordance with production requirements.

Preferably, the first deck screening media is sized to size the first sizing screen oversize product in accordance with the sized crushed product. The first sizing screen oversize product can therefore be combined with the sized crushed product without being crushed. Wherein the term “size” as used herein, such as in “sized to size”, may comprise at least one of discriminate, differentiate. For example, the first deck screening media may be sized to discriminate the first screen oversize product (from the remains of the undersize fraction). The term “sized” as used herein, is intended to refer to dimensions of openings of respective screening media.

Generally, an oversize product of a screening media may be a product that is oversized for said screening media, i.e. a product that does not pass through the screening media, such as openings of the screening media. Thereby different screening media may “size” products in accordance with a respective oversize of the different screening media. By the term “produce” as used herein, such as “a screening deck or screening media configured to produce” it is generally referred to an ability of the screening deck or screening media to differentiate and trap material of a relevant size for outputting such material.

In one embodiment, the first upper deck and a second and third lower deck of the three screening decks comprise screening media sized to produce the second fines product as a throughput product. The second fines product does not therefore enter the crusher and can be treated as a graded finished product. A throughput product may have a particle size that can pass through a respective screen media of the first, second and third deck.

Suitably, the second and third lower decks comprise screening media sized to produce the third intermediate sized product as a second and third lower deck oversize product. This oversize product therefore results in an additional saleable product.

Suitably, the second lower deck screening media differs from the first deck screening media may be configured to size different products. For example, the first deck screening media may comprise openings being larger than openings (if present) of the second lower deck screening media.

In any embodiment, the crusher feed station further comprises a third intermediate sized product conveyor for conveying the third intermediate product from the crusher feed station. The third intermediate sized product conveyor can remove the third intermediate sized product from the crusher feed station for bagging and the like.

In any embodiment, the crusher feed station further comprises a fines product conveyor for conveying the fines product from the crusher feed station. The fines product conveyor removes the fines product from the crusher feed station for bagging etc.

In any embodiment, the sizing screen comprises a vibrating sizing screen. The vibrating screen effectively screens the undersize (underflow) fraction.

In any embodiment, the primary feeder comprises a vibrating pan feeder. The vibrating pan feeder effectively feeds the feed material to the scalping deck.

The undersize fraction may form a first underflow that descends vertically from the oversize crusher feed to the first sizing screen.

The first sizing screen may be configured to remove the first sizing screen oversize product to form a second underflow that descends vertically from the first sizing screen to the second lower deck 130, in particular the second lower deck screening media 160.

The second lower deck 130, in particular the screening media 160 of the second lower deck 130, may be configured to remove the intermediate sized product from the second underflow product as an oversize product of the second deck, i.e. the second lower deck screening media, to form a third underflow that descends vertically to the screening media 170 of the third lower deck 140.

In any embodiment, the primary feeder may be configured to convey the feed material along the feed direction of the feed station. The primary feeder may be configured to convey the feed material in a substantially horizontal direction.

In any embodiment, the scalping deck may be contiguous with the primary feeder.

In any embodiment, the primary feeder 90 may be disposed in a feed hopper 80. The primary feeder 90 may extend from the feed hopper towards the scalping deck 100. The scalping deck 100 may be positioned immediately above the sizing screen 110.

In any embodiment, oversize crusher feed is fed along the feed direction of the feed station past the scalping deck.

In any embodiment, the first underflow is fed along the feed direction of the feed station throughout the longitudinal extension of the feed station.

In any embodiment, the second underflow is fed along the feed direction of the feed station.

In any embodiment, the third screening deck comprises a discharge end adjacent a fines product conveyor 190. Thus, the fines product conveyor may be configured to receive product from the discharge end of the third screening deck.

In any embodiment, the second deck comprises a discharge end adjacent, preferably immediately above a third intermediate sized product conveyor 180 for conveying the intermediate product away from the feed station as a finished product.

In any embodiment, the mechanical diverter. The mechanical diverter may be displaceable. The diverter may comprise a pivotably attached end, such as a hinged end, and a displaceable free end. The diverter may be displaceable between first diverting position and a second position.

The diverter may be provided immediately downstream the intermediate product conveyor, in the feed direction. The diverter may be displaced, such as pivoted, for example pivoted in respect of the vertical, to attain the first diverting position. In the diverting position the diverter may project along a horizontal direction at least partially over the intermediate product conveyor, to thereby by-pass the intermediate sized product from the second lower deck, for example to a further conveyor, such as the discharge conveyor.

In any embodiment, the displaceable mechanical diverter configured to selectively receive material from the first upper deck or the second lower deck, in particular from respective discharge ends of the first upper deck and the second lower deck. This configuration advantageously allows for selectively by-passing material, such as the third intermediate product from the second lower deck past the intermediate product conveyor 180. Thus, the third intermediate sized product may be mixed with first screen oversize product or it may be conveyed by the intermediate product conveyor 180. The diverter may be provided in shape of a pivotable member, such as plate or hatch, having a receiving end and a discharge end, wherein the receiving end is displaceable between the first upper deck and the second lower deck, in particular between respective discharge ends of the first upper deck and the second lower deck.

In another embodiment, the invention also extends to a crusher comprising a crusher feed station as hereinbefore defined. A crusher incorporating the crusher feed station exhibits optimal efficiency as a high percentage of undersize material is removed before crushing and a clean, saleable third intermediate product in addition to the second fines product is produced.

In one embodiment, the crusher further comprises a discharge conveyor for conveying sized crushed product from the crusher and the discharge conveyor is located beneath a discharge end of the sizing screen to receive first sizing screen oversize product from the sizing screen. The discharge conveyor therefore conveys both sized crushed product and first sizing screen oversize product from the crusher.

In any embodiment, the crusher comprises a jaw crusher, a cone crusher or an impact crusher.

In another embodiment, the invention also extends to a method of feeding feed material from a feeding station to a crusher configured to produce a sized crushed product from the feed material, the method comprising:
scalping the feed material on a scalping deck at the feeding station to form a scalping deck oversize crusher feed and an undersize (underflow) fraction, and
screening the undersize (underflow) fraction at the feeding station with a sizing screen having at least three screening decks to form a first sizing screen oversize product, a second fines product and a third intermediate sized product. The method therefore optimises crusher efficiency by removing a high percentage of undersize material and producing a clean, saleable third intermediate product in addition to the second fines product.

In one embodiment, the method further comprises feeding the scalping deck oversize crusher to the crusher, such as directly to the crusher.

In one embodiment, the undersize (underflow) fraction is screened by a first upper deck of the three screening decks to produce the first sizing screen oversize product. The first sizing screen oversize product is therefore sized as required in accordance with production requirements.

In one embodiment, the undersize (underflow) fraction is screened by the first upper deck and a second and third lower deck of the three screening decks to produce the second fines product as a throughput product and by the second and third lower decks to produce the third intermediate product as a second and third lower deck oversize product. The method therefore results in the production of two finished or saleable products at the material feed stage of the production process.

### BRIEF DESCRIPTION OF THE DRAWINGS

The invention will now be described, by way of example only, with reference to the accompanying drawings in which:

FIG. 1 is a perspective view from above and one side of a crusher provided with a crusher feed station of the invention in which the crusher is a mobile primary jaw crusher and the crusher feed station is made up of a primary feeder, a scalping deck and a sizing screen having three sizing decks;

FIG. 2 is a side elevation of the crusher of FIG. 1;

FIG. 3 is an enlarged perspective view from above and one side of the crusher feed station and associated feed hopper and primary feeder separated from the crusher of FIGS. 1 and 2 to more clearly illustrate the crusher feed station;

FIG. 4 is a side elevation of the crusher feed station, feed hopper and primary feeder of FIG. 3 with the direction of movement of bulk material through the feed station indicated by the arrows, and

FIG. 5 is a further enlarged view of the crusher feed station and primary feeder of FIGS. 3 and 4 to more clearly illustrate the three screening decks of the sizing screen and the path of bulk materials through the scalping deck.

### DETAILED DESCRIPTION OF THE INVENTION

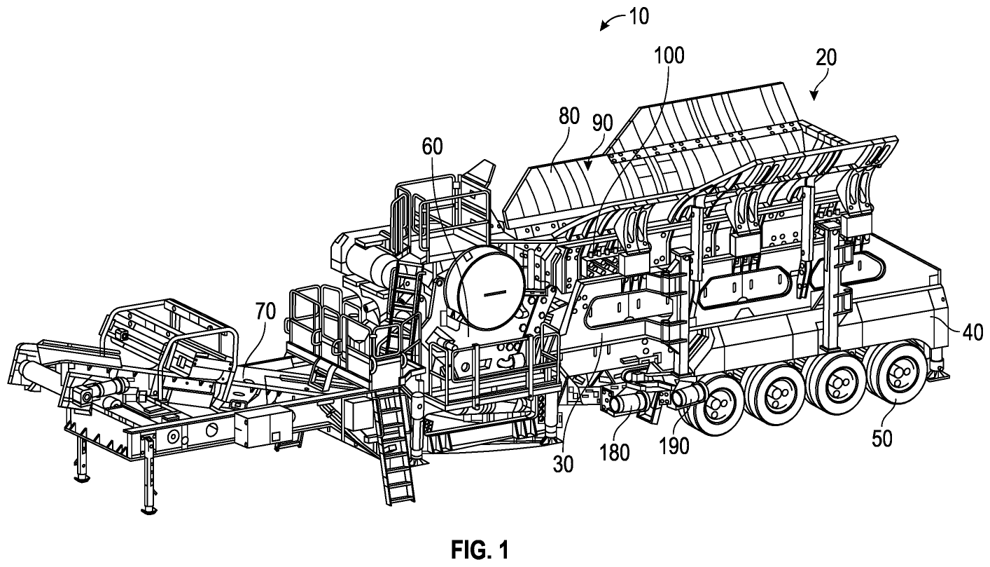

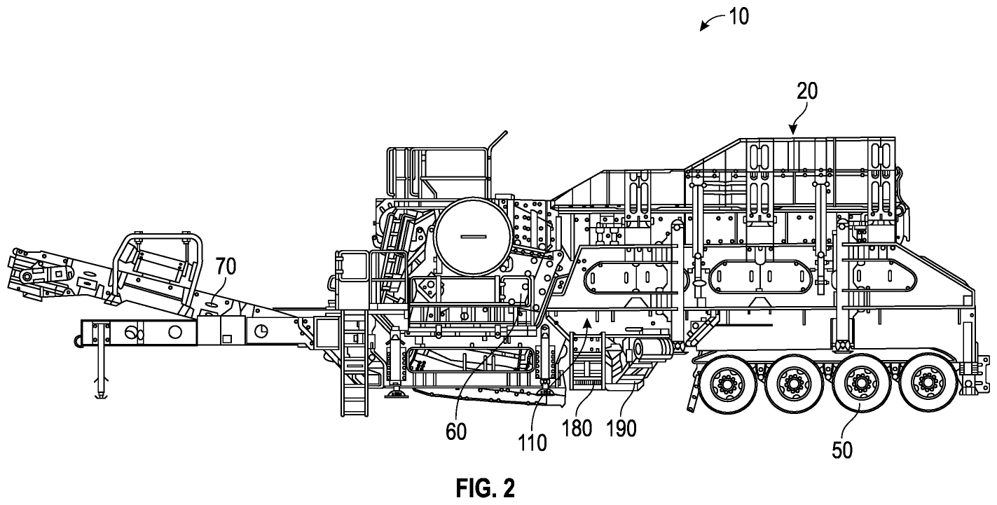

FIGS. 1 and 2 show a mobile crusher 10 provided with a crusher feed station 20 of the invention in which the mobile crusher 10 is generally made up of a mainframe 30 on a chassis 40 provided with wheels 50 and a jaw crusher 60 mounted on the mainframe 30 for crushing bulk material to form a crushed main product which is conveyed from the mobile crusher 10 on a main product discharge conveyor 70 disposed beneath the jaw crusher 60. As shall be explained more fully below, the crusher feed station 20, which can be mounted on the mainframe 30 to receive bulk material from a feed hopper 80 and a primary feeder 90 also mounted on the mainframe 30, has a scalping deck 100 and a sizing screen 110 configured to produce a first sizing screen oversize product, a second fines product and a third intermediate sized product.

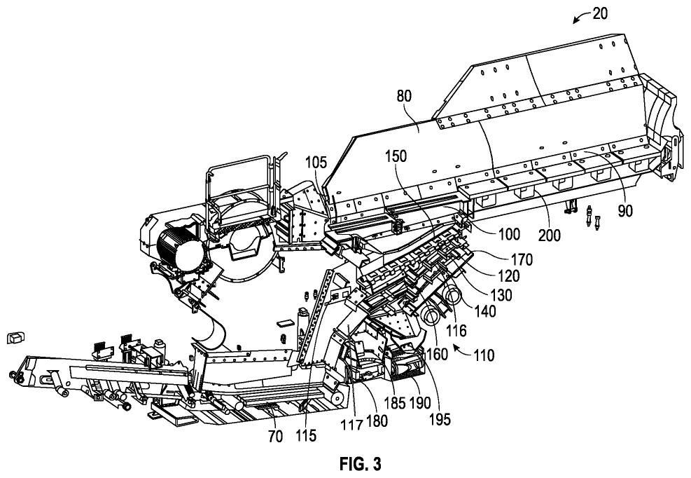

FIG. 3 shows an enlarged perspective view from above and one side of the crusher feed station 20 and associated feed hopper 80 and primary feeder 90 separated from the mobile crusher 10. As shown in the drawing, the primary feeder 90 is disposed in feed hopper 80 and extends from the feed hopper 80 towards the scalping deck 100 which is positioned above the sizing screen 110. The scalping deck 100 terminates at a scalping deck discharge end 105 from which a scalping deck oversize feed is fed from the scalping deck 100 into the jaw crusher 60 (see also FIGS. 1 and 2) for crushing.

The sizing screen 110 is disposed beneath the scalping deck 100 for screening the undersize (underflow) fraction from the scalping deck 100 and has a sizing screen discharge end 115 for discharging screened material from the sizing screen 110. The sizing screen 110 is a triple deck sizing screen 116 having a first upper screening deck 120 disposed immediately beneath the scalping deck 100, a second or middle screening deck 130 disposed beneath the upper screening deck 120 and a third or lower screening deck 140 disposed beneath the second screening deck 130.

In order to produce the first sizing screen oversize product, the second fines product and the third intermediate sized product, the upper screening deck 120 is provided with an upper deck screening media 150, the second screening deck 130 is provided with a second deck screening media 160 and the third screening 140 deck is provided with a third deck screening media 170. The first deck screening media 150 is sized to produce the first sizing screen oversize product e.g. in accordance with the sized crushed product. The first upper screening deck 120, the second screening deck 130 and the third lower screening deck 140 have respective screening media 150,160,170 sized to produce the second fines product as a throughput product. The screening media 160 of the second screening deck 130 and the screening media 170 of the third lower screening deck 140 are also sized to produce the third intermediate sized product as a second screening deck 130 and third lower screening deck 140 oversize product.

The crusher feed station 20 is further provided with a third intermediate sized product conveyor 180 disposed beneath the sizing screen discharge end 115 of the second screening deck 130 and the third lower screening deck 140 to convey the third intermediate product from the crusher feed station 20. The longitudinal axis of the third intermediate sized product conveyor 180 is disposed substantially perpendicular to the longitudinal axis of the sizing screen 110 and a chute 185 is positioned above the third intermediate product conveyor 180 to guide the third intermediate product onto the third intermediate product conveyor 180. In addition, the crusher feed station 20 is also provided with a fines product conveyor 190 adjacent the third intermediate sized product conveyor 180 and disposed beneath the third lower screening deck 170 for conveying the fines product from the crusher feed station 20 and a chute 195 is also positioned above the fines product conveyor 190 to guide the fines product onto the fines product conveyor 190. The longitudinal axis of the fines product conveyor 190 is also disposed substantially perpendicular to the longitudinal axis of the sizing screen 110.

As shown in the drawing, the discharge conveyor 70 for conveying sized crushed product from the jaw crusher 60 (see also FIGS. 1 and 2) is also located beneath the discharge end 115 of the sizing screen 110 to receive the first sizing screen oversize product from the sizing screen 110 so that the first sizing screen oversize product is combined with the sized crushed product.

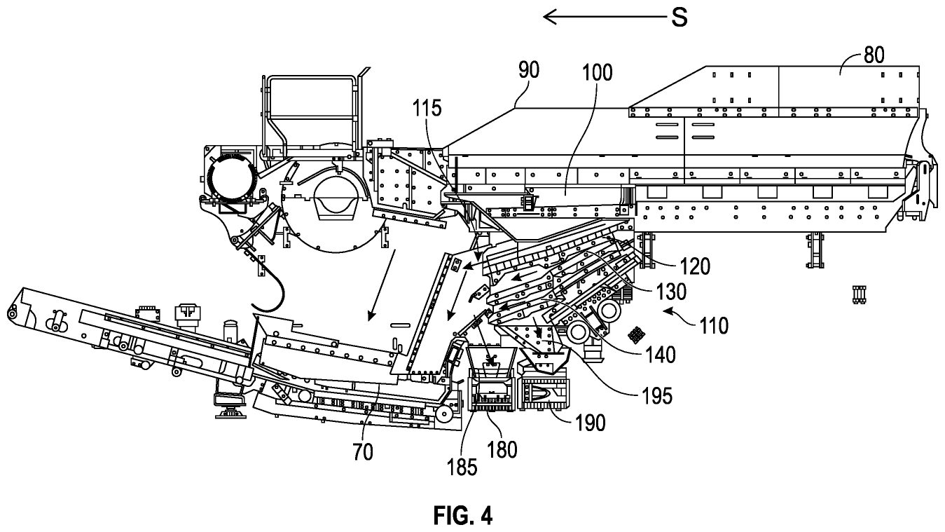

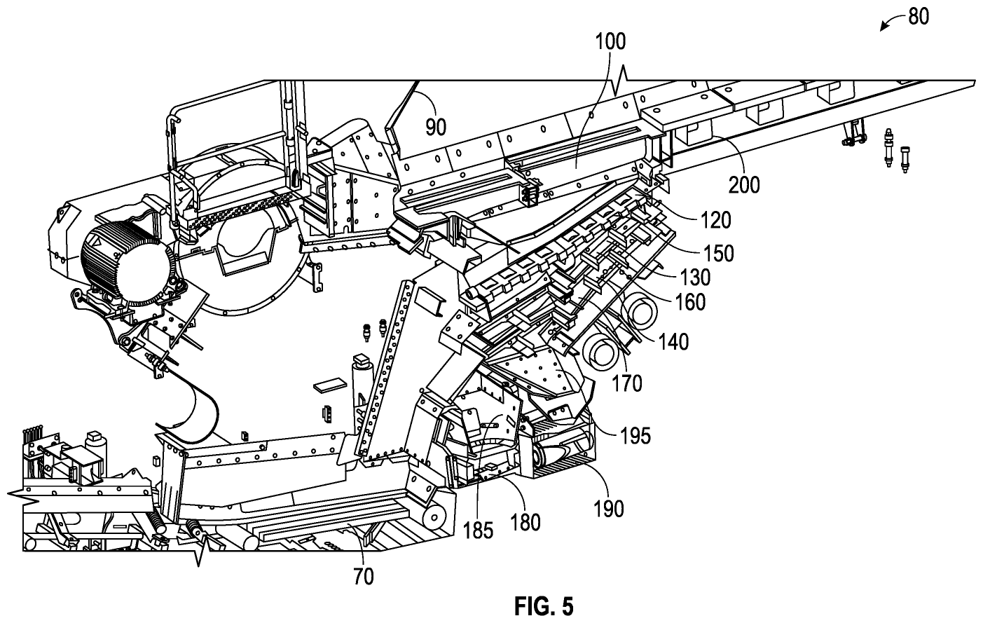

The operation of the crusher feed station 20 will now be described having regard to FIGS. 4 and 5 in which the direction of movement of bulk material through the feed station 20 is indicated by the arrows in FIG. 4 and the three screening decks 120,130,140 of the sizing screen 110 are more clearly illustrated in FIG. 5.

As shown in the drawings, feed material from the hopper 80 is conveyed by the primary feeder 90, which is typically a vibrating pan feeder 200, to the scalping deck 100. The scalping deck 100 removes undersize materials from the feed material to form a scalping deck oversize crusher feed and an undersize (underflow) fraction and the scalping deck oversize crusher feed is fed to the jaw crusher 60 (see FIGS. 1 and 2) for crushing and removal as a sized crushed product by the main product discharge conveyor 70 (see also FIG. 2) and the undersize (underflow) fraction descends to the triple deck sizing screen 110 for further processing.

At the triple deck sizing screen 110, the screening media 150 of the first upper deck 120 screens the material to produce the first sizing screen oversize product. Typically, the first deck screening media 150 is sized to size the first sizing screen oversize product in accordance with the sized crushed product which descends from the discharge end 115 of the sizing screen 110 onto the main product discharge conveyor 70.

The screening media 150,160,170 of the first upper screening deck 120, the second screening deck 130 and the third screening deck 140 are sized so that throughput product that passes through the three screening decks 120,130,140 forms the second fines product which is conveyed from the feed station 20 by the fines product conveyor 190 as finished processed product.

In addition, the respective screening media 160,170 of the second and third lower decks 130,140 are sized to produce the third intermediate sized product as a second and third lower deck 130,140 oversize product which descends from the discharge end 115 of the sizing screen 110 onto the third intermediate product conveyor 180 which conveys the third intermediate product from the feed station 20 as an additional finished processed product.

The scalping deck 100 and screening media 150,160,170 can be configured and sized as required in accordance with the desired sizes and grades of the finished products. For example, in one configuration, the maximum opening on scalping deck of the primary feeder is 150 mm so that oversize material passes to the jaw crusher 60 (see also FIGS. 1 and 2) for crushing and the undersize fraction falls onto the sizing screen 110 where first upper deck screening media has openings of 120 mm to achieve about a 100 mm product pass through. As indicated above, the second and third screening decks 130,140 are configurable by the end user with one suitable configuration being 75 mm openings in the second deck screening media 160 and 25 mm openings in the third lower deck screening media 170 on lower deck. Accordingly, in this configuration, the first sizing screen oversize product having a size of about 100 mm+ is sent to the jaw crusher 60 or to the main product conveyor 70 depending on requirements, material sized between from about 25 to about 75 mm forms the third intermediate sized product and is discharged onto the third intermediate product conveyor 180 and material less than about 25 mm in size forms the fines product as a throughput product which is discharged onto the fines product conveyor 190. In this configuration, the main product from the mobile crusher 10 has a size of about 150 mm down to dust.

Referring again to FIG. 3, the feed station comprises a displaceable mechanical diverter 117. The diverter 117 is configured to selectively receive material from the first upper deck 120 or the second lower deck 130, in particular from respective discharge ends of the first upper deck 120 and the second lower deck 130. This configuration advantageously allows for selectively by-passing material, such as the third intermediate product from the second lower deck 130 past the intermediate product conveyor 180. Consequently, the third intermediate sized product may be mixed with first screen oversize product or it may be conveyed by the intermediate product conveyor 180. The diverter 117 is provided in shape of a pivotable member, such as a pivotable plate or hatch as shown in FIG. 3. The diverter 117 has a receiving end and a discharge end. The receiving end is displaceable between the first upper deck 120 and the second lower deck 130, in particular between the respective discharge ends of the first upper deck and the second lower deck.

Referring to FIG. 4, the crusher feed station 20 has a general feed direction S along a longitudinal direction of the feed station 20. In any embodiment, the feed station is configured to feed the scalping deck oversize crusher feed and the undersize fraction along the feed direction S. Preferably, the undersize fraction is fed, i.e. flows, immediately beneath the oversize crusher feed.

Each deck of the at least three screening decks 120, 130, 140 may extend along the feeding direction from a respective upstream receiving end to a downstream discharge end of the at least three screening decks.

The scalping deck oversize crusher feed and undersize flow are continuously fed in the feed direction of the feed station, at least until discharged to respective conveyors 70, 180, 190, as derivable e.g. from FIG. 4.

1. A crusher feed station arranged for feeding feed material to a crusher configured to produce a sized crushed product, the crusher feed station comprising:
a primary feeder;
a scalping deck arranged for removing undersize materials from the feed material to form a scalping deck oversize crusher feed and an undersize, underflow fraction, and
a sizing screen beneath the scalping deck for screening the undersize, underflow, wherein the sizing screen includes at least three screening decks configured to produce a first, sizing screen oversize product, a second, fine product and a third, intermediate sized product.

2. The crusher feed station as claimed in claim 1, wherein a first upper deck of the three screening decks includes a first deck screening media sized to produce the first, sizing screen oversize product.

3. The crusher feed station as claimed in claim 2, wherein the first deck screening media is sized to size the first, sizing screen oversize product in accordance with the sized crushed product.

4. The crusher feed station as claimed in claim 2, wherein the first upper deck and a second and third lower deck of the three screening decks include screening media sized to produce the second fines product as a throughput product.

5. The crusher feed station as claimed in claim 4, wherein the second and third lower decks include screening media sized to produce the third, intermediate sized product as a second and third lower deck oversize product.

6. The crusher feed station as claimed in claim 1, further comprising a third, intermediate sized product conveyor for conveying the third intermediate product from the crusher feed station.

7. The crusher feed station as claimed in claim 1, further comprising a fines product conveyor for conveying the fines product from the crusher feed station.

8. The crusher feed station as claimed in claim 1, wherein the sizing screen includes a vibrating sizing screen.

9. The crusher feed station as claimed in claim 1, wherein the primary feeder includes a vibrating pan feeder.

10. A crusher comprising a crusher feed station as claimed in claim 1.

11. The crusher as claimed in claim 10, wherein the crusher further comprises a discharge conveyor for conveying sized crushed product from the crusher, and wherein the discharge conveyor is located beneath a discharge end of the sizing screen to receive first sizing screen oversize product from the sizing screen.

12. The crusher as claimed in claim 10, wherein the crusher includes a jaw crusher, a cone crusher or an impact crusher.

13. A method of feeding feed material from a feeding station to a crusher configured to produce a sized crushed product from the feed material, the method comprising:
scalping the feed material on a scalping deck at the feeding station to form a scalping deck oversize crusher feed and an undersize, underflow fraction, and
screening the undersize, underflow fraction at the feeding station (20) with a sizing screen having at least three screening decks to form a first, sizing screen oversize product, a second, fines product and a third, intermediate sized product.

14. The method as claimed in claim 13, wherein the undersize, underflow fraction is screened by a first upper deck of the three screening decks to produce the first, sizing screen oversize product.

15. The method as claimed in claim 14, wherein the undersize, underflow fraction is screened by the first upper deck and a second and third lower deck of the three screening decks to produce the second, fines product as a throughput product and by the second and third lower decks to produce the third, intermediate product as a second and third lower deck oversize product.
